(19) United States
(12) Patent Application Publication
(10) Pub. No.: US 2026/0160314 A1
(43) Pub. Date: Jun. 11, 2026

(54) ROTARY VISCOUS DAMPING APPARATUSES AND APPROACH

(71) Applicant: Wisconsin Alumni Research Foundation, Madison, WI (US)

(72) Inventors: Joshua W. Gollub, Madison, WI (US); Ryan M. McAdams, Madison, WI (US); Joseph W. Byrne, Madison, WI (US); Meghan M. Horan, Madison, WI (US); Nicole S. Parmenter, Madison, WI (US); Sydney A. Polzin, Madison, WI (US); Greta E. Scheidt, Madison, WI (US); Joshua M. Varghese, Madison, WI (US)

(21) Appl. No.: 18/972,542

(22) Filed: Dec. 6, 2024

(51) Int. Cl. F16F 15/02

(52) U.S. Cl. CPC F16F 15/022

(57) ABSTRACT

Aspects of the disclosure are directed damping motion of a platform, such as to isolate vibration and/or other movement from a suspended tray for holding a neonate. As may be implemented in accordance with various embodiments, an apparatus includes a platform support connected to a damping mechanism. The damping mechanism includes a rotary viscous damper having a piston that rotates about a horizontal axis, and a housing that holds viscous fluid in which a portion of the piston resides. The damping mechanism also includes a damper arm having a first end coupled to the platform support and a second end coupled to the piston. The damper arm rotates in a plane with the second end rotating about the horizontal axis and the first end traversing an arc having the horizontal axis as its center. A spring applies a force to the damper arm relative to rotation thereof.

### BACKGROUND

For many applications, it is desirable to isolate movement such as vibrations from an object, for example as may be present during transportation.

As an example application, the transportation of newborns, and in particular neonates (newborns less than four weeks old), can be particularly challenging as vibrations can cause damage. In instances where a neonate faces health complications, the newborn may require immediate access to advanced medical equipment and specialized care that may not be available in a standard hospital setting. As a result, transfer to another hospital or care facility is common. This transport, however, can subject the neonate to conditions that harm their health. Vibrations transferred from road conditions through emergency vehicles can lead to harmful impacts on susceptible patients'bodies. Whole-body vibrations (WBV) are correlated with a variety of adverse health outcomes. In underweight, preterm, or critically ill neonatal patients, WBV leads to increased risks of brain injury. In the United States alone, 480,000 premature infants are born each year and over 68,000 require transport. Transportation of a neonate has been shown to increase the odds of severe brain injury.

These and other matters have presented challenges transferring/moving newborns or other objects, for a variety of applications.

### SUMMARY

Various example embodiments are directed to dampers, their application and their manufacture. Such embodiments may be useful for reducing or eliminating vibrations or other movement, for a multitude of applications.

Aspects of the disclosure relate to a damping mechanism designed to isolate vibration and other movement from a suspended tray, particularly for neonatal transport. In particular aspects, an apparatus includes a platform support connected to a damping mechanism having a rotary viscous damper, a piston that rotates about a horizontal axis, and a housing containing viscous fluid to dampen rotational motion. A damper arm connects the platform support to the piston, rotating in a vertical plane, with a spring providing resistance to the damper arm's movement, thereby reducing vibrational impacts. This design effectively addresses whole-body vibrations in neonates, mitigating risks of brain injury during transport. The apparatus is adaptable to various configurations to suit specific vibration-damping applications.

As may be implemented in accordance with one or more particular embodiments, an apparatus comprises a platform support and a damping mechanism connected to the platform support. The damping mechanism includes a rotary viscous damper, a damper arm and a spring. The rotary viscous damper has a piston configured to rotate about a horizontal axis, and a housing configured to hold viscous fluid in which a portion of the piston resides. The damper arm has a first end coupled to the platform support and a second end coupled to the piston, and is configured to rotate in a vertical plane with the second end rotating about the horizontal axis and the first end traversing an arc having the horizontal axis as its center. The spring is configured to apply a spring force to the damper arm relative to rotation thereof.

Another embodiment is directed to an apparatus comprising a tray to hold one or more objects, a plurality of platform supports respectively coupled to the tray and to an underlying base, and a damper mechanism for each of the platform supports. Each damper mechanism includes a rotary viscous damper, a damper arm and a spring. The rotary viscous damper has a piston configured to rotate about a horizontal axis, a housing having a viscous fluid in which a portion of the piston resides, and one or more seals coupled to seal the viscous fluid within the housing. The damper arm has a first end coupled to the platform support and a second end coupled to the piston. The damper arm is configured to rotate in a vertical plane, with the second end rotating about the horizontal axis and the first end traversing an arc having the horizontal axis as its center. The spring is configured to apply a spring force to the damper arm relative to rotation thereof, by engaging with a surface of the housing and a surface of the damper arm. The apparatus also includes a cap coupled to the housing and configured to apply pressure to the piston in a direction along the horizontal axis to maintain the piston within the housing.

Another embodiment is directed to a method as follows. A platform support and a damping mechanism connected to the platform support are provided. The damping mechanism includes a rotary viscous damper having a piston configured to rotate about a horizontal axis, and having a housing configured to hold viscous fluid in which a portion of the piston resides. The damping mechanism further includes damper arm having a first end coupled to the platform support and a second end coupled to the piston, the damper arm being configured to rotate in a vertical plane with the second end rotating about the horizontal axis and the first end traversing an arc having the horizontal axis as its center. In addition, the damping mechanism includes a spring configured to apply a spring force to the damper arm relative to rotation thereof. Movement of a platform connected to the platform support is damped using the rotary viscous damper and the spring to dampen rotation of the damper arm about the horizontal axis.

The above discussion/summary is not intended to describe each embodiment or every implementation of the present disclosure. The figures and detailed description that follow also exemplify various embodiments.

### BRIEF DESCRIPTION OF FIGURES

Various example embodiments may be more completely understood in consideration of the following detailed description and in connection with the accompanying drawings, in which:

FIGS. 1A-1F show an apparatus as may be implemented in accordance with one or more embodiments, in which:

FIG. 1A shows an oblique view of the apparatus,

FIG. 1B shows a left side view of the apparatus,

FIG. 1C shows a right side view of the apparatus,

FIG. 1D shows a piston of a rotary viscous damper of the apparatus,

FIG. 1E shows a housing of the apparatus, and

FIG. 1F shows a cross-sectional view of the piston of FIG. 1D, with exemplary seals;

FIGS. 2A-2C show an apparatus including a suspended platform and a damping mechanism as may be implemented in accordance with various embodiments, in which:

FIG. 2A shows an oblique view of the apparatus,

FIG. 2B shows a right side view of the apparatus, and

FIG. 2C shows a front view of the apparatus;

FIG. 3 shows an apparatus including a suspended platform and both vertical and horizontal damping mechanisms as may be implemented in accordance with various embodiments;

FIG. 4 shows an apparatus including a suspended platform and a damping mechanism for both vertical and horizontal damping, as may be implemented in accordance with various embodiments;

FIG. 5 shows an apparatus including a suspended platform and both vertical and horizontal damping mechanisms as may be implemented in accordance with various embodiments; and

FIGS. 6A and 6B show a diagonal rotary viscous damper mechanism as may be implemented in accordance with various embodiments, and in which:

FIG. 6A depicts a housing with an extended inclined surface for coupling with a damper arm positioned at an angle, and

FIG. 6B depicts a joint extended from the piston to facilitate coupling of a damper component to the extended inclined surface shown in FIG. 6A.

While various embodiments discussed herein are amenable to modifications and alternative forms, aspects thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the disclosure including aspects defined in the claims. In addition, the term “example” as may be used throughout this application is by way of illustration, and not limitation.

### DETAILED DESCRIPTION

Aspects of the present disclosure are believed to be applicable to a variety of different types of articles of manufacture, apparatuses, systems and methods involving damping of movement/vibration. In certain implementations, aspects of the present disclosure have been shown to be beneficial when used in the context of transporting newborns or other patients susceptible to adverse implications of movement/vibrations. While not necessarily so limited, various aspects may be appreciated through a discussion of examples using such exemplary contexts.

In accordance with various embodiments, a spring and damper apparatus utilizes one or more rotary viscous dampers and one or more springs to reduce movement/vibrations. Such an apparatus may be utilized to reduce whole-body vibrations (WBV) during transport, for example by coupling to a support structure/platform to address issues such as those characterized above with respect to the transportation of neonates. The spring and damper apparatus may mitigate acceleration and the amplitude of vibrations, for example in the vertical Z direction. The apparatus may be part of or can be integrated with a variety of types of neonatal transport componentry (e.g., including an incubator), providing a practical and effective solution for improving the safety of neonatal transport.

The spring component opposes displacement by developing restorative forces and the damper component slows motion by dissipating energy. It has been recognized/discovered that using both a spring and a damper in one system combats two different effects of vibrations and can produce promising results in a variety of applications. The sum of forces acting in a spring and damper combination in parallel can be modeled by Equation 1, where m is the mass, c is the damping coefficient, and k is the spring constant.

$$\sum F = m \ddot{y} + c \dot{y} + ky \qquad ( 1 )$$

The spring constant and damping coefficient can be varied to achieve a desired frequency response. For instance, vibrations may be reduced below 0.315 m/s² in the human sensitivity range of 3-20 Hz. The apparatus may mitigate vibrations near the natural frequency of 17 Hz, and reduce the natural frequency from 19.96 Hz to 6.76 Hz, thereby providing a frequency shift and reducing/minimizing the risk of vibrations falling within the harmful human sensitivity range.

In a more specific embodiment, the rotary viscous damper includes a cylindrical piston and housing with fluid in which the piston rotates, and is connected in parallel with the spring (e.g., a linear spring). Two or more spring and damper combinations may be placed between a base and a suspended platform (e.g., a tray supporting a mattress and neonate). The damper and spring combinations may provide a controlled deceleration of the platform via a cylindrical piston rotating in a viscous fluid. The piston and fluid are housed in an outer casing and may be secured by a seal, with pin extending from the center of the piston and connected to a damper arm that suspends the platform. An airtight seal may be established, for example using an O-ring fitted into a gland at the top of the piston, and a U-cup seal that fits securely around the pin where it extends through a hole in the cap. The U-cup seal may facilitate rotation as it resists rolling or moving when the piston rotates or translates linearly. Other types of seals, such as lip seals and wiper seals, may be utilized in various embodiments.

The damper arm may move along one axis, facilitating rotational displacement of the cylindrical piston in response to applied loads. A linear guide rail may be implemented to maintain a fixed connection to the platform, and may facilitate access to the tray by allowing it to slide in and out (e.g., of an incubator). The damper arm rests on top of the linear spring, which may be oriented perpendicular to a baseplate that it is secured to. The surface of the baseplate with which the spring engages may be oriented at an angle (e.g., 15 degrees relative to the horizontal), reflective of a resting, pre-loaded angle of the damper arm. The surface of the baseplate may also be adjustable to set or tune the angle of orientation of the spring. Further, the stiffness of the spring may be set to suit particular applications, for instance by providing/using different springs for different applications. The spring may rest in an indent in a casing housing the piston. It has been recognized/discovered that this of the baseplate orientation is particularly useful for adding linear spring support to the rotary viscous damping, with respect to achieving desirable damping. When vertical forces are applied to the platform causing the arm of the damper to rotate downward, the linear spring deflects, establishing a storage of potential energy. The spring can then apply an opposing restorative force to return both the platform and spring to their equilibrium positions. Accordingly, the dimensions, fluid viscosity (as may account for a range of weights), and spring may be selected based upon a desired spring constant and damping coefficient, for instance 12.67 lbs/in and 0.854 lbs-s-in, respectively.

In another particular embodiment, an apparatus includes a platform (or tray) support connected to a damping mechanism. The platform support may be further coupled to a platform or tray, for example to hold an object such as a neonate. The damping mechanism includes a rotary viscous damper, a damper arm and a spring. The rotary viscous damper has a piston that rotates about a horizontal axis, and a housing that holds viscous fluid in which a portion of the piston resides. The piston may include a rod or shaft having a proximal end that resides partially within the housing with a distal end extending out of the housing and connected to the damper arm. A first end of the damper arm is coupled to the platform support, and a second end of the damper arm is coupled to the piston. The damper arm rotates in a vertical plane, for example as may be fixed by coupling of the damper arm to the platform support, with the second end rotating about the horizontal axis (via connection to the piston) and the first end traversing an arc having the horizontal axis as its center. The spring applies a spring force to the damper arm relative to rotation thereof, for example in compression as the damper arm rotates toward the spring, or in extension as the damper arm rotates away from the spring. One or more seals may be provided to seal the viscous fluid in the housing, for example such as an O-ring as may be utilized within a gland region of the piston, a U-cup seal around an end of the piston protruding from the housing, or a combination thereof.

The housing may be implemented in a variety of manners. In some instances, the housing has an internal cavity that is larger than the piston. This facilitated interaction of the viscous fluid with a surface of the piston for damping rotation of the piston. The housing may include the viscous fluid, for example as may be added during a manufacturing process or as implemented for use. The viscous fluid may operate with the piston to dampen movement of the platform support, by interacting with the piston to dampen changes in rotational torque applied to the piston via the damper arm, in response to the movement of the platform support. In certain embodiments, the housing has a surface that is angled relative to a pre-loaded angle of the damper arm in a resting state, to orient the spring perpendicularly to the damper arm in the resting state.

The spring can be implemented to dampen changes in rotation of the piston by resisting rotation of the first end of the piston about the arc. This may involve resisting movement of the arm toward the spring (compressive resistance), or resisting movement of the arm away from the spring (tensile resistance).

The piston may be implemented in a variety of manners. In some instances, the piston has a barrel residing in the housing and a recessed gland region near an end of the barrel adjacent an opening in the housing. A seal such as an O-ring may be provided in the recessed gland region to maintain the viscous fluid within the housing. An end of the piston extending out of the housing may be machined or otherwise formed to provide a pin at the distal end of the piston, for coupling to the damper arm.

Another embodiment is directed to an apparatus including a tray to hold one or more objects, platform supports respectively coupled to the tray and to an underlying base, and a damper mechanism for each of the platform supports. Each damper mechanism includes a rotary viscous damper, a damper arm and a spring. The rotary viscous damper has a piston configured to rotate about a horizontal axis, a housing having a viscous fluid in which a portion of the piston resides, and one or more seals coupled to seal the viscous fluid within the housing. The damper arm has first and second ends respectively coupled to the platform support and the piston. The damper arm rotates in a vertical plane, with the second end rotating about the horizontal axis and the first end traversing an arc having the horizontal axis as its center. The spring applies a spring force to the damper arm relative to rotation thereof, by engaging with a surface of the housing and a surface of the damper arm. A cap is coupled to the housing to apply pressure to the piston in a direction along the horizontal axis to maintain the piston within the housing.

In certain embodiments, the housing includes a spring support surface that is inclined at an angle relative to a plane in which the horizontal axis lies. The spring support surface is parallel to a surface of the damper arm in a resting state corresponding to resting position of the damper arm with a predefined load in the tray. The spring is perpendicular to the spring support surface and the surface of the damper arm, in the resting state.

The piston may include a barrel section and a pin end/section having a diameter that is smaller than the outside diameter, the barrel being part of a proximal end of the piston inserted within the housing, and the pin being part of a distal end that extends away from an opening in the housing and the barrel to engage with the damper arm. The barrel section may include a gland region located adjacent the opening of the housing and having a diameter that is less than the outside diameter of the barrel section. An O-ring may be utilized in the gland region, extending from the diameter of the gland region to an outside diameter of the barrel section while inserted in the housing. The O-ring may thus engage with an outer surface of the gland region and an inner sidewall of the housing to provide a seal that maintains the viscous fluid within the housing. A U-cup seal may be coupled to abut a distal end of the barrel section with the pin extending through the seal.

The viscous fluid may operate with the piston to dampen movement of the platform support, by interacting with the piston to dampen changes in rotational torque applied to the piston via the damper arm, in response to the movement of the platform support. The spring may resist movement of the damper arm by applying one or both of a compressive force that counters movement of the damper arm toward the spring, and an extension/tensile force that counters movement of the damper arm away from the spring.

Another embodiment is directed to a method as follows. A platform support and a damping mechanism connected to the platform support are provided. The damping mechanism includes a rotary viscous damper having a piston configured to rotate about a horizontal axis, and having a housing configured to hold viscous fluid in which a portion of the piston resides. The damping mechanism further includes damper arm having a first end coupled to the platform support and a second end coupled to the piston, the damper arm being configured to rotate in a vertical plane with the second end rotating about the horizontal axis and the first end traversing an arc having the horizontal axis as its center. In addition, the damping mechanism includes a spring configured to apply a spring force to the damper arm relative to rotation thereof. Movement of a platform connected to the platform support is damped using the rotary viscous damper and the spring to dampen rotation of the damper arm about the horizontal axis.

The viscous fluid may be used to dampen movement of the platform support (e.g., in the Z direction) by interacting with the piston to dampen changes in rotational torque applied to the piston via the damper arm, in response to the movement of the platform support. The spring may be utilized to resist movement of the damper arm by applying one or both of a compressive force that counters movement of the damper arm toward the spring, and an extension force that counters movement of the damper arm away from the spring. A plurality of the platform supports and damping mechanisms may be used together, with a damping mechanism for each platform support. Each platform support is coupled to a tray and restricts motion of the respective damper arms of the damping mechanisms to movement within respective vertical planes.

In certain embodiments, additional rotary viscous dampers or linear spring-damper combinations are implemented to mitigate vibrations in other directions. For instance, where a tray is supported as noted above for mitigating vibrations along a Z axis (relative to horizontal positioning of the tray), additional dampers may be provided in the X-and/or Y-directions. These dampers may be mounted orthogonally to the Z-axis damping mechanism and tuned to address lateral accelerations commonly encountered in transport vehicles.

In some embodiments, a damping apparatus as characterized herein is arranged in a diagonal configuration, with dampers oriented at angles (e.g., 45°) relative to the X, Y, and Z axes. This setup combines the benefits of Z-direction damping with lateral (X and Y axes) vibration mitigation. In a particular implementation, a suspended tray rests on a frame supported by four diagonal dampers, each mounted at a 45°angle extending outward from the tray's corners to the frame's base. Rotary viscous dampers with pistons oriented along diagonal axes may be paired with springs as characterized herein, to enhance resistance to vibrations.

Certain embodiments may employ a dual-stage damping system to enhance performance across a wide frequency range. The first stage provides coarse damping of low-frequency, high-amplitude vibrations, while the second stage targets high-frequency, low-amplitude vibrations with finer dampers or viscoelastic materials. The first stage may use rotary viscous dampers with large pistons and high-viscosity fluids for significant energy absorption at low frequencies. The second stage may use softer linear springs or viscoelastic foam layers optimized for higher frequencies. These stages may be placed in series between the tray and base structure, in which the first stage may manage initial inputs and the second stage refines the system's response to residual oscillations.

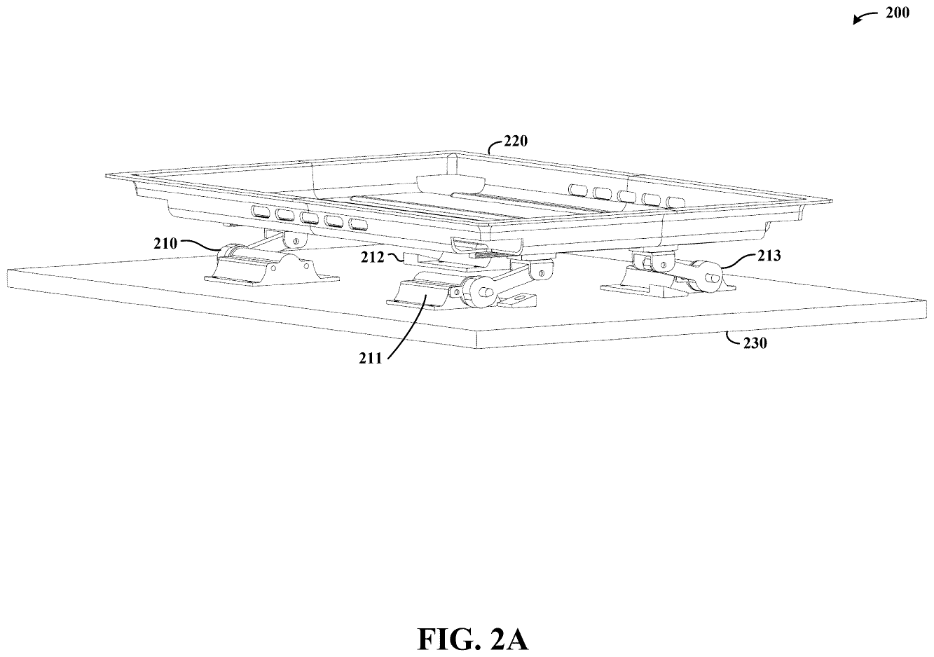

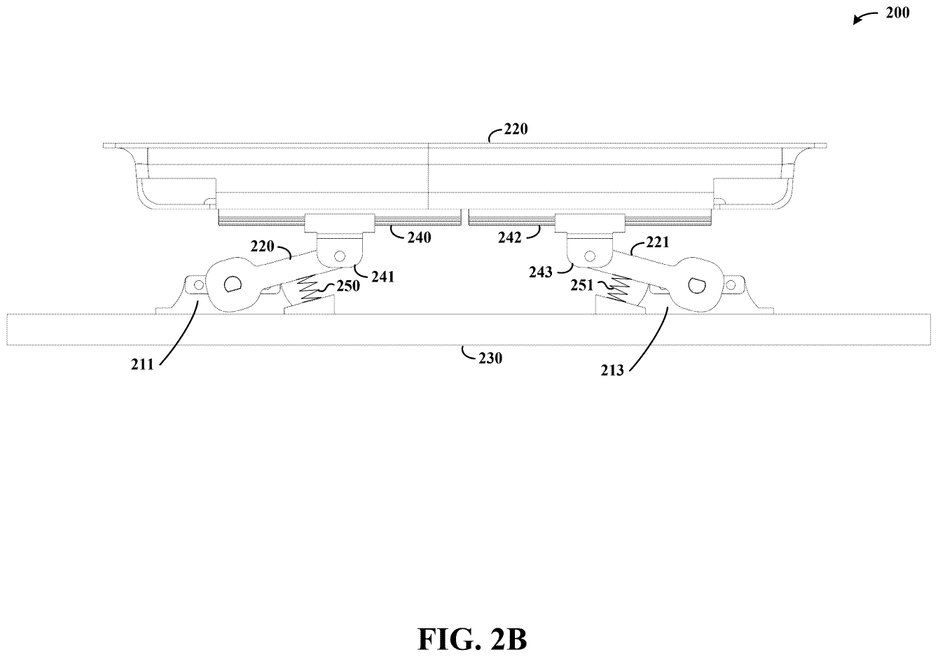

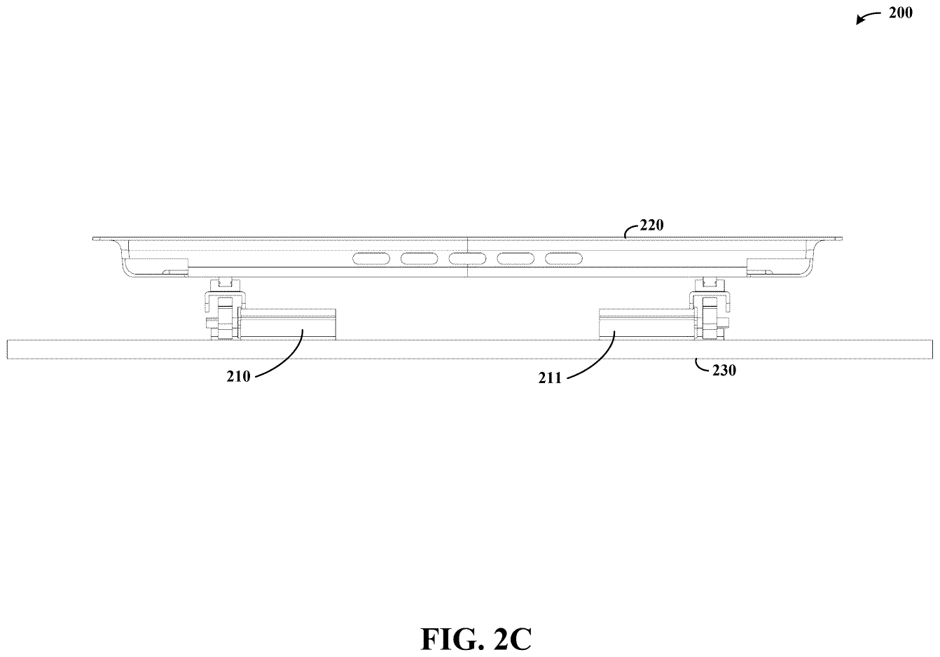

Certain embodiments may incorporate nonlinear or variable stiffness springs to adapt to different weights and vibration intensities. These springs dynamically adjust resistance based on the applied load or vibration amplitude, providing a tailored damping response. In some implementations, conical springs are used to provide progressive stiffness, softening under lighter loads and stiffening as loads increase. Nested spring arrangements can be used, for example by combining a soft inner spring with a stiffer outer spring for a smooth transition between damping modes. An adjustable pre-load mechanism may be used fine-tune initial tension, optimizing performance for specific neonatal weights. These embodiments may be implemented with others characterized herein, such as those shown in FIGS. 2B, 3, 4 and 5.

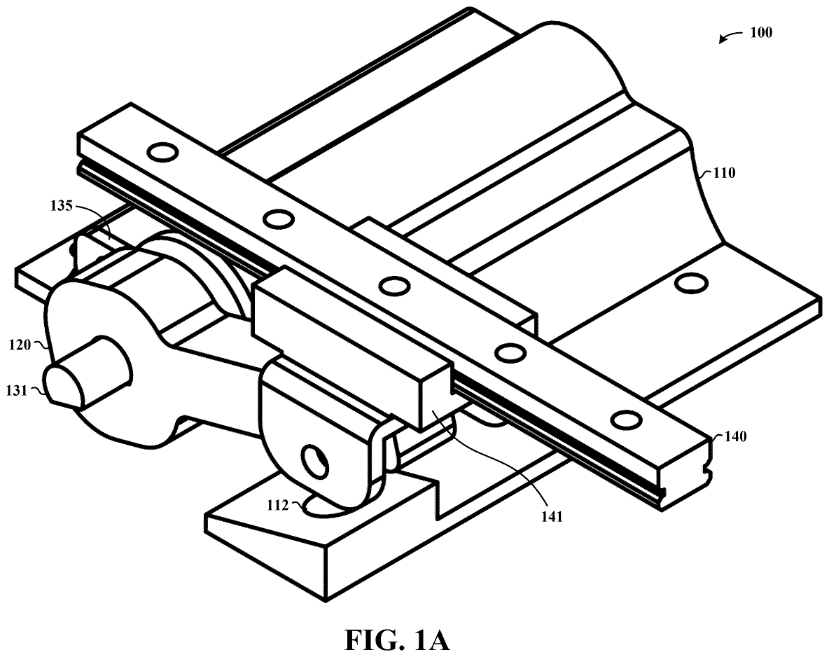

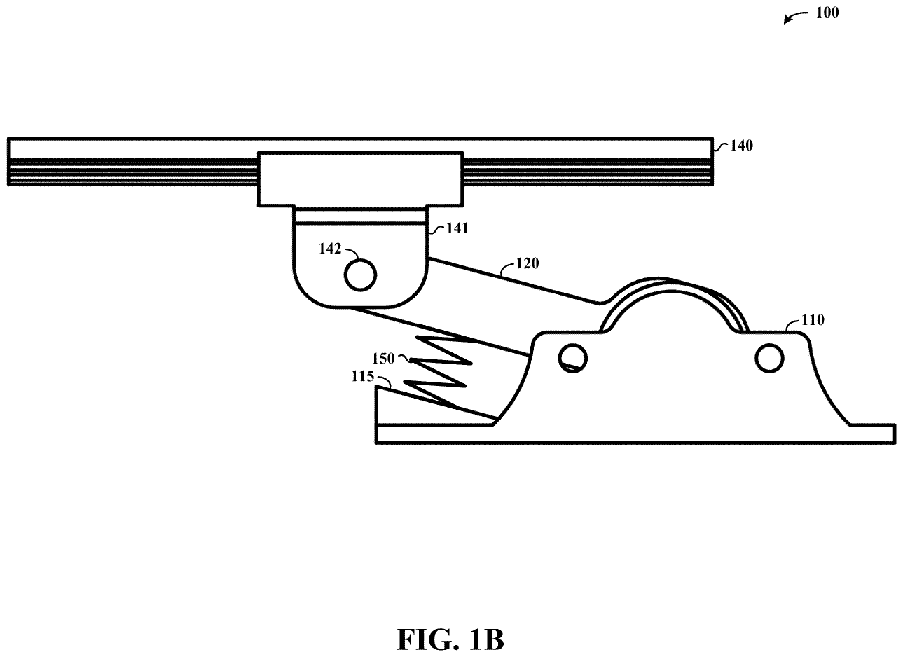

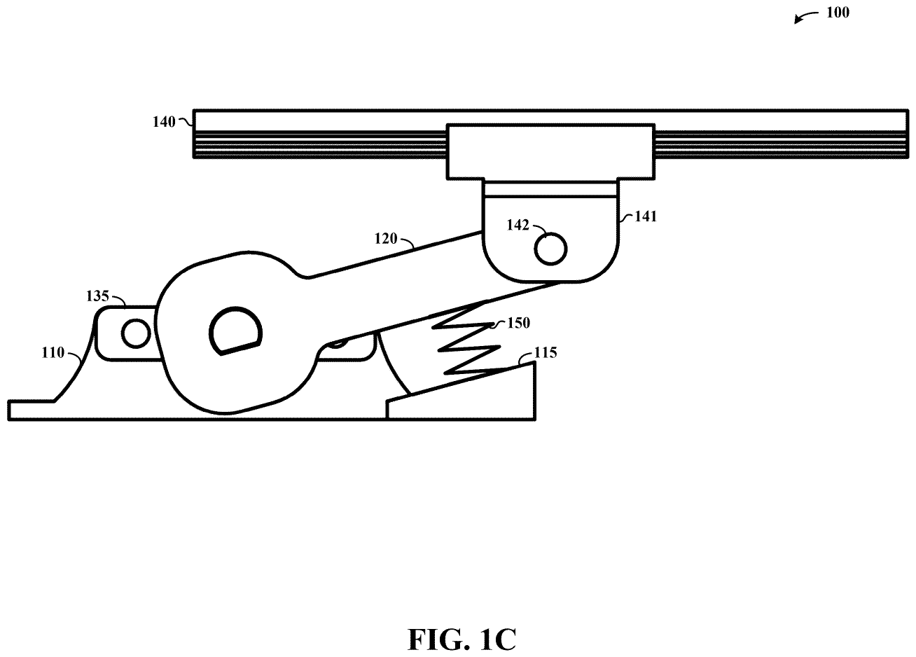

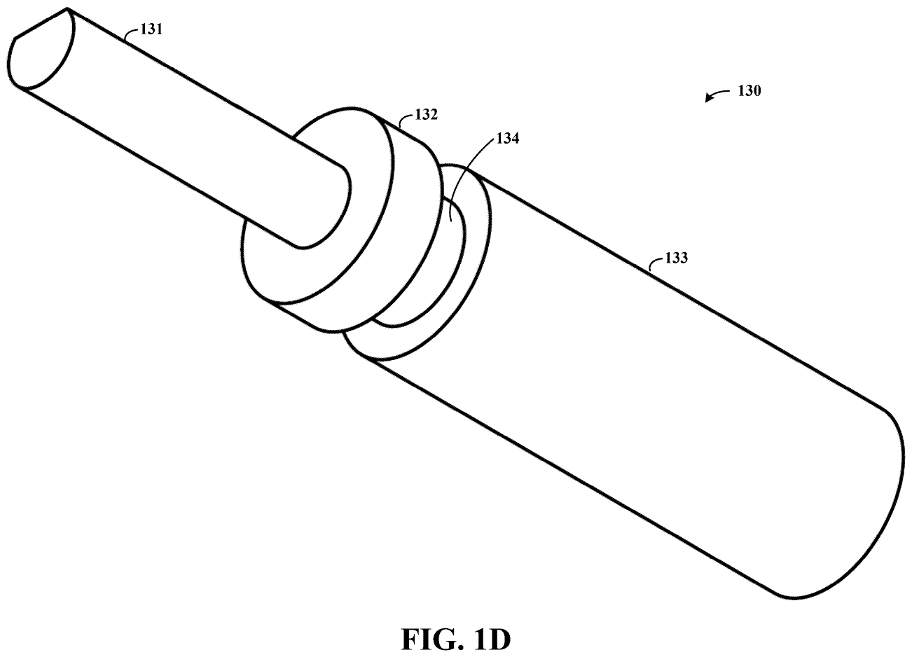

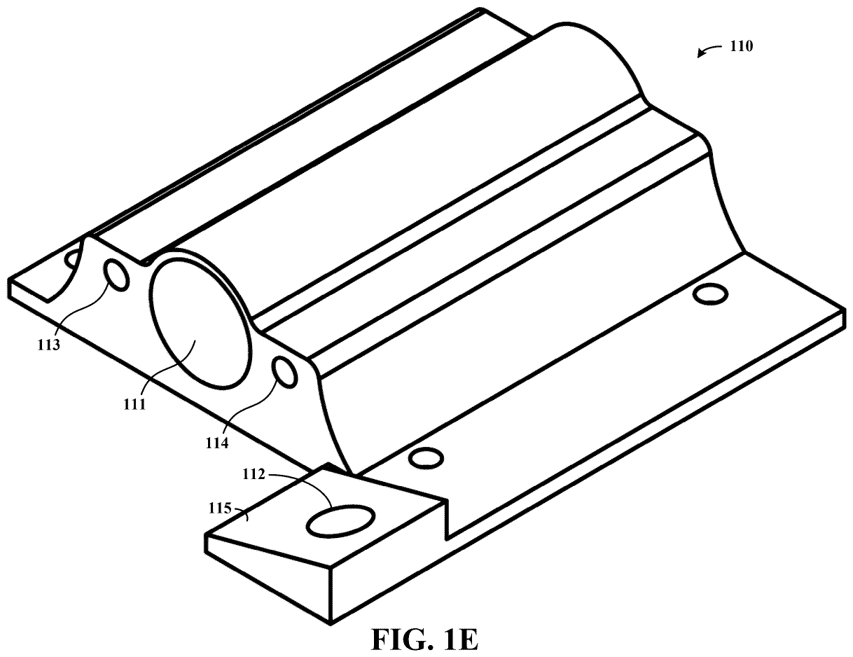

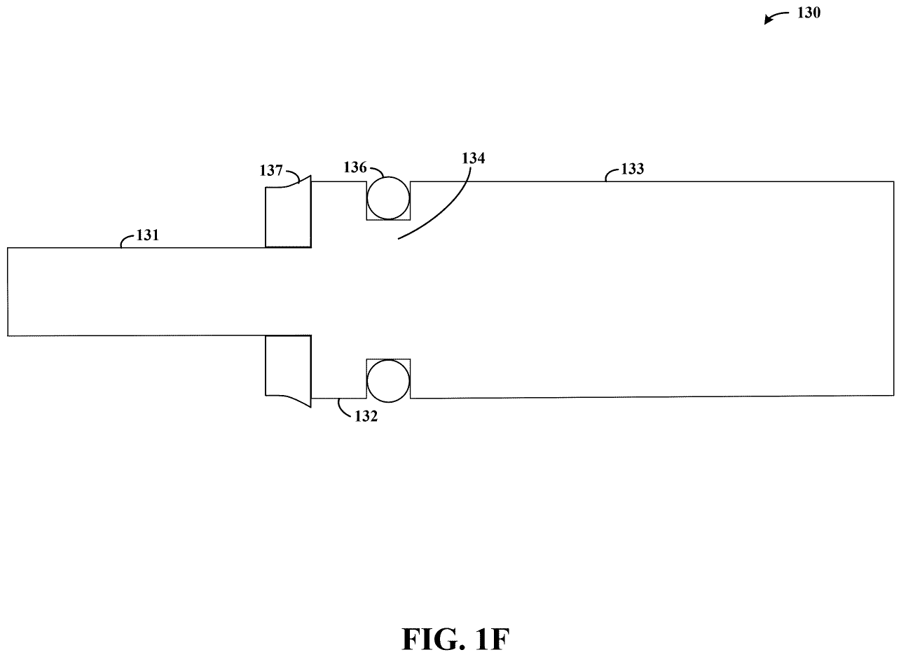

Turning now to the figures, FIGS. 1A-1F show an apparatus 100, as may be implemented in accordance with one or more embodiments. The views include oblique (FIG. 1A), left side (FIG. 1B), and right side (FIG. 1C), as well as a view of a rotary viscous damper piston 130 in FIG. 1D, a housing 110 in FIG. 1E and a cross-sectional view of the piston 130 with exemplary seals in FIG. 1F. Referring to FIG. 1A, the apparatus 100 includes the housing 110, a damper arm 120, the piston 130 (See FIG. 1D) within the housing 110 and having a pin 131 at an end of the piston extending along an axis thereof and coupled to the damper arm. A platform support 140 is coupled to a free end of the damper arm 120 via a bracket 141. The bracket 141 is coupled to the damper arm 120 with a pin 142, as shown in FIGS. 1B and 1C. A spring 150 as shown in FIGS. 1B and 1C (and omitted from FIG. 1A for clarity), is coupled to damp movement of the damper arm 120, for example in compression and/or extension. As shown in FIG. 1A, a recess 112 may optionally be utilized for the spring.

Referring to FIG. 1D, the piston 130 includes the pin 131, which is an extension of a piston barrel having respective portions 132 and 133 and a recessed gland region 134. The piston barrel may be inserted into opening 111 in the housing 110, as shown in FIG. 1E. A viscous fluid may be placed into the opening 111 prior to insertion of the piston barrel portion 133, and the piston 130 may be secured to the housing (e.g., to form an airtight seal) by coupling a cap 135 to the housing, for example using a threaded fastener and threaded openings 113 and 114.

As also shown in FIG. 1E, surface 115 of the housing may be angled relative to an angle of the damper arm 120 in a resting state. As shown in FIGS. 1B and 1C, this angle may be set such that the damper arm 120 and angled surface are about parallel, with the spring 150 aligned generally perpendicularly to the damper arm in the resting position as shown.

A variety of types of seals may be used to maintain the viscous fluid within the housing 110. Referring to FIG. 1F, a cross-sectional view of the piston 130 is shown with an O-ring 136 in the gland region 134, as may be placed prior to insertion of the piston barrel into the housing 110. FIG. 1F also shows a U-cup seal 137 placed over the pin 131 and against piston barrel portion 132, with the pin 131 extending through the seal. The O-ring 136 and U-cup seal 137 may be utilized separately or together as shown.

The apparatus 100 may be implemented in a variety of manners. In a particular embodiment, the apparatus 100 is implemented to suspend an object such as a transportation platform holding a neonate. Damping aspects of the apparatus 100 cause a controlled deceleration of the platform via rotation of the piston 130 in a viscous fluid within the housing 110. Two or more such apparatuses 100 may be coupled to the platform, which is coupled to platform support 140 and suspended by the respective damper arms 120.

The dimensions, fluid viscosity, and spring characteristics may be chosen to achieve desired damping for a particular application, and thus may be different for different applications. As one example, the spring 150 has a spring constant of 12.67 lbs/in, and the apparatus has an overall damping coefficient of 0.854 lbs-s-in for a target mass of 7 kg (e.g., to include a neonate and gel mattress). Such an approach can reduce the power of the vibrations at the natural frequency of the undamped system, for example of 17 Hz.

FIGS. 2A-2C show an apparatus 200 including a suspended platform (or tray) 220 and damping componentry, with FIG. 2A showing an oblique view, FIG. 2B showing a right side view, and FIG. 2C showing a front view of the apparatus. The damping componentry includes four dampers, 210, 211, 212 and 213, each of which may be implemented utilizing an apparatus as shown in FIGS. 1A-1F. The dampers are coupled to a base 230, for example as part of a mobile incubator carrier. Each damper includes a rotary viscous damper connected in parallel with a linear spring. Where four such combinations are used, each may be positioned relative to each corner of the suspended transport mechanism as shown. Fewer or more dampers may be used, to suit particular applications. Similarly, different attachment locations may be used for particular implementations. In certain embodiments, additional dampers are provided in the X and Y directions to diminish the impact of these motions. Additionally, platform supports 240 and 242 may be aligned along the front edge of the platform rather than the side edge.

Referring to FIG. 2B, dampers 211 and 213 are shown, having damper arms 220 and 221, platform supports 240 and 242, brackets 241 and 243, and springs 250 and 251. Dampers 210 and 212 may be similarly implemented. Further, the dampers may be implemented as shown in FIGS. 1B and 1C, and as described in connection therewith. In a particular implementation, the platform 220 is a tray used to support a mattress and a neonate, with the dampers implemented to facilitate a controlled deceleration of the platform 220 (and contents therein), via rotation of the pistons in a viscous fluid, and via corresponding operation of the spring in each of the dampers.

The damper arms extend diagonally across the width of the platform 220, and are secured on the under surface of the platform 220 through brackets (including 241 and 242, as well as similar brackets for the other dampers. This attachment mechanism allows free linear movement of the damper arm along one axis, facilitating the rotational displacement of the cylindrical piston of each damper in response to applied loads. Concurrently, the platform supports restrict movement in other directions and maintain a fixed connection to the platform 220. In addition to connection with the platform 220, the damper arms rest on the springs, which may be aligned perpendicular the housing. The housing support for the spring may be oriented in a variety of positions, for example such as 15 degrees relative to the horizontal as characterized herein, reflective of the resting, pre-loaded angle of the damper arm. This angle may be adjustable, for example by adding or removing pieces of the housing support and/or via implementation of an adjustable support (e.g., adjustably coupled to the housing). When vertical forces are applied to the platform 220, causing the damper arms to rotate down, the springs deflect, establishing a storage of potential energy. The springs can then apply an opposing restorative force to return both the tray and spring to their equilibrium positions.

The apparatuses characterized herein may be manufactured in a variety of manners, utilizing a variety of materials. In a particular instance, the cap and casing of the rotary viscous damper design are 3D printed, the piston is fabricated from Grade 2011 aluminum stock, and the damper arms are fabricated from 6061 flat bar stock aluminum. An airtight seal to prevent leakage of viscous fluid from the inside of the rotary viscous damper is established through the usage of an O-ring and a U-cup seal. The viscous fluid includes vegetable oil, with a viscosity of 42.3 cSt, corresponding to the calculated viscosity for desired damping. The spring has a leg length of 0.75″, an outer diameter of 0.3″, and a spring constant of 12.64 lb/in. U-brackets are utilized to hold the dampers.

To prepare the piston for damper assembly, the O-ring may be fit into a gland near the top of the piston, and the U-cup seal may be placed over the pin until it is flush with the barrel portion of the piston. The casing is filed approximately a quarter full with viscous fluid and the piston is inserted so that it sits in the bottom recess of the casing. The cap is then secured to the casing by feeding screws through the holes on either side of the opening and locking them in place with hex nuts. The damper arm is then fed onto the piston until it is flush with the end of the flat on the pin. It is secured in place with an O-ring on the other side of the arm. After the placement of all four dampers, stoppers are inserted into outermost holes of a linear guide rail (to couple to a platform) to alleviate the identified long-way rocking and lateral motions.

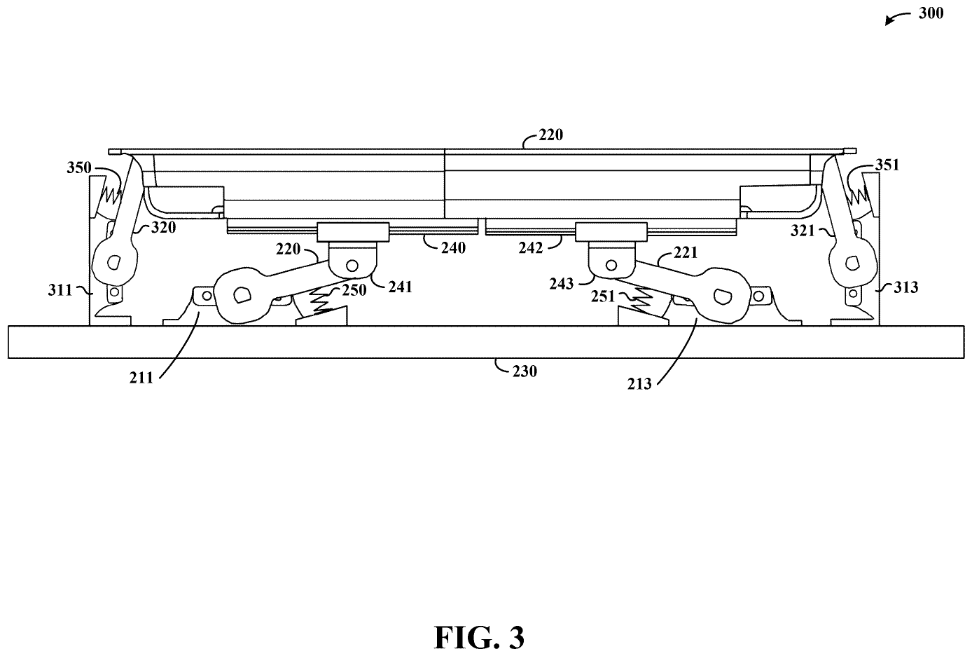

FIG. 3 shows an apparatus 300 including a suspended platform 220 and both vertical and horizontal damping mechanisms, as may be implemented in accordance with various embodiments. The apparatus 300 may utilize components that correspond to those depicted in FIG. 2B that use common reference numbers, the description of which is provided herein. Additional horizontal (e.g., in the “X” or “Y” direction) damping mechanisms are provided, with dampers 311 and 313 having damper arms 320 and 321, and springs 350 and 351. Additional dampers may be similarly coupled to the platform 220 to provide horizontal damping in a direction orthogonal to the damping provided by dampers 311 and 313.

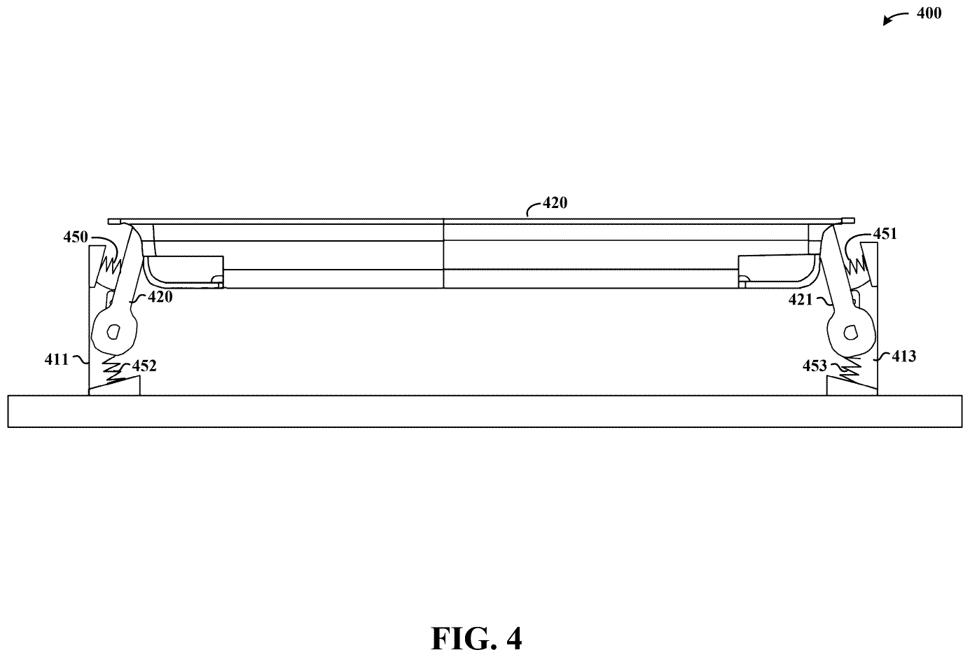

FIG. 4 shows an apparatus 400 including a suspended platform 420 and a damping mechanism for both vertical and horizontal damping, as may be implemented in accordance with various embodiments. The apparatus 400 includes dampers 411 and 413 having damper arms 420 and 421, and springs 450, 451, 452 and 453. Springs 450 and 451 may be implemented for horizontal damping in a manner similar to springs 250 and 251 as shown in FIG. 2B. Springs 452 and 453 are provided for additional (e.g., vertical) damping.

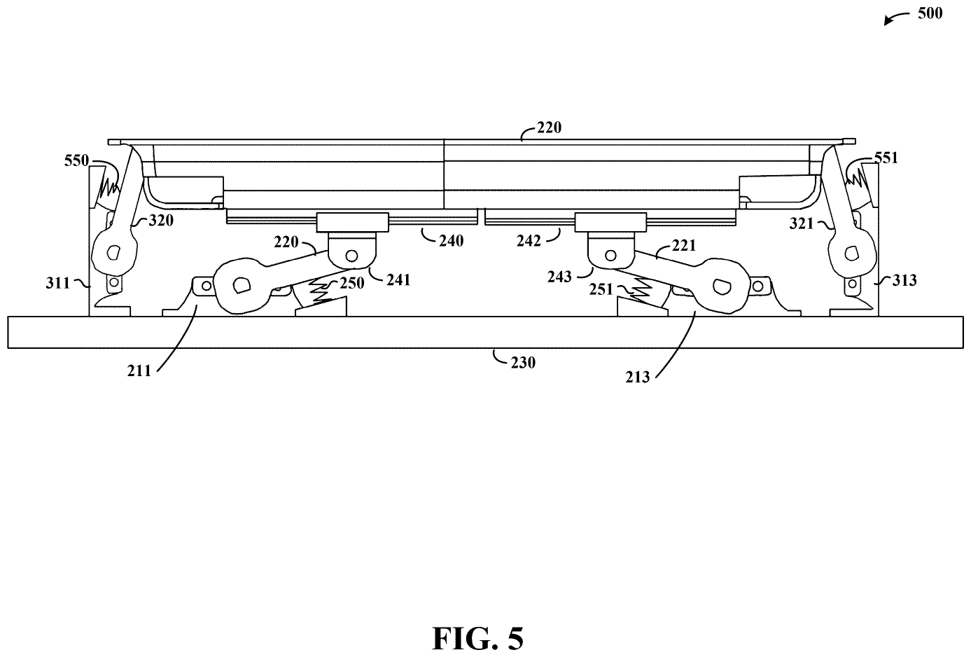

FIG. 5 shows another apparatus 500 including a suspended platform and both vertical and horizontal damping mechanisms as may be implemented in accordance with various embodiments. The apparatus 500 may utilize components that correspond to those depicted in FIG. 3 that use common reference numbers, the description of which is provided herein. Springs 550 and 551 are conical, as may be useful for tuning the springs to particular applications, supported weights, etc.

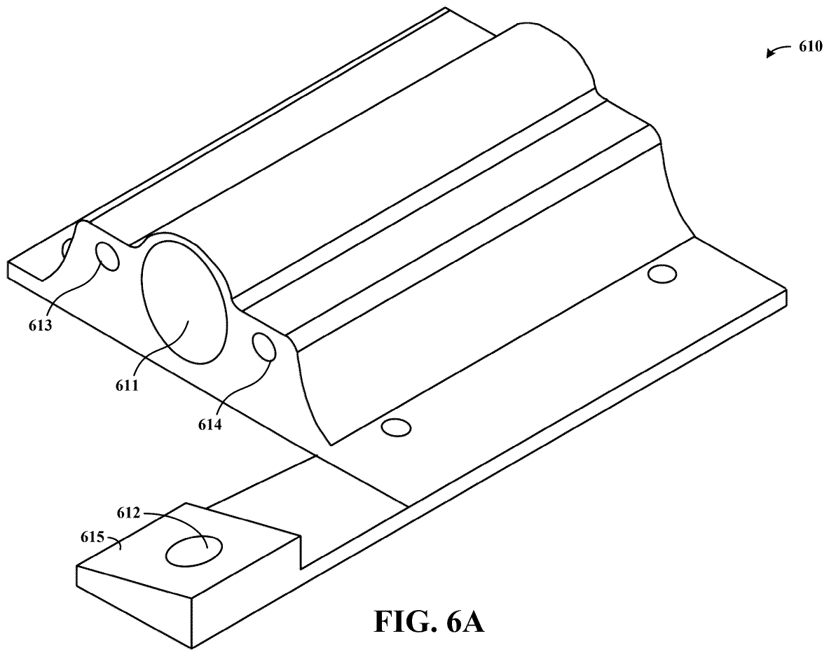

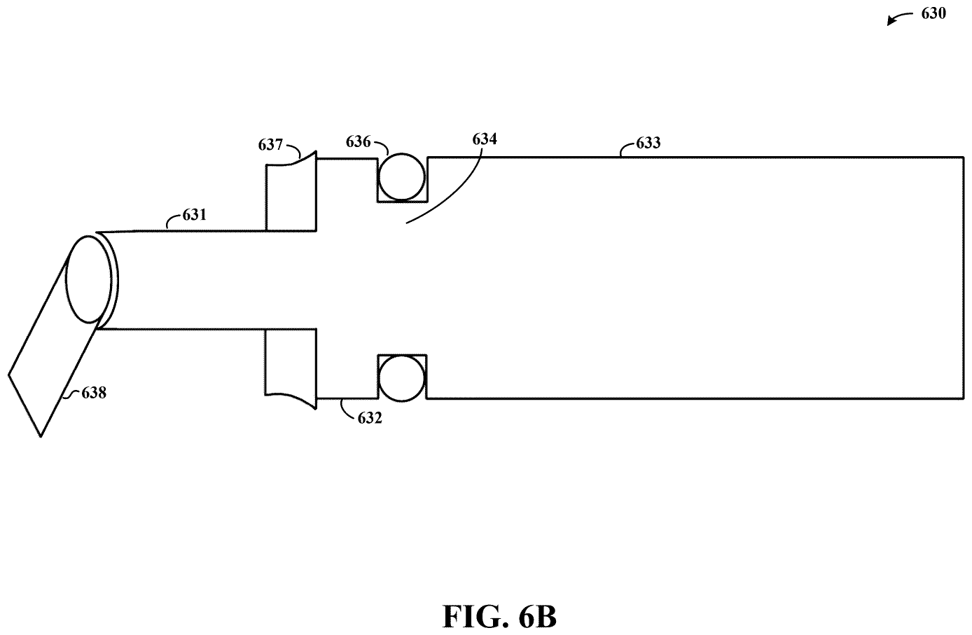

FIGS. 6A and 6B show a diagonal rotary viscous damper mechanism as may be implemented in accordance with various embodiments. FIG. 6A depicts a housing 610 with an extended inclined surface for coupling with a damper arm positioned at an angle. FIG. 6B depicts a joint extended from a piston 630 to facilitate coupling of a damper component to the extended inclined surface shown in FIG. 6A. The housing 610 is similar to the housing 110 shown in FIG. 1E, with opening 611 to receive a piston, and optional threaded openings 613 and 614 for securing the piston to the housing. A recess 612 in an inclined surface 615 may be utilized for supporting a spring, such as spring 350 of FIG. 3.

The piston 630 may be implemented in a manner similar to the piston shown in FIGS. 1D and 1F. The piston 630 includes a pin 631 as an extension of a piston barrel having respective portions 632 and 633 and a recessed gland region 634. The piston barrel may be inserted into opening 611 in the housing 610, as shown in FIG. 6A. A viscous fluid may be placed into the opening 611 prior to insertion of the piston barrel portion 633, and the piston 630 may be secured to the housing (e.g., to form an airtight seal) by coupling to the housing using a threaded fastener and openings 613 and 614. An O-ring 636 is located in the gland region 634, as may be placed prior to insertion of the piston barrel into the housing 610. A U-cup seal 637 is placed over the pin 631 and against piston barrel portion 632, with the pin extending through the seal. A joint 638, such as a ball-and-socket joint, extends from the piston to allow the damper component to reach the inclined surface 615.

Based upon the above discussion and illustrations, those skilled in the art will readily recognize that various modifications and changes may be made to the various embodiments without strictly following the exemplary embodiments and applications illustrated and described herein. For example, additional springs or other dampers may be utilized to suit particular applications, for example to provide both vertical and horizontal damping in two or more of X, Y and Z directions. In addition the housing may be formed in a variety of manners, to hold pistons in a variety of orientations. Further, dampers may be implemented for other directions of movement, to suit particular applications. Relative to indicated orientations, terms such as “horizontal” or “vertical” are exemplary and the related embodiments may be implemented with similarly-related components aligned in different directions. Such modifications do not depart from the true spirit and scope of various aspects of the invention, including aspects set forth in the claims.

What is claimed is:

1. An apparatus comprising:
a platform support; and
a damping mechanism connected to the platform support, including:
a rotary viscous damper having a piston configured to rotate about a horizontal axis, and having a housing configured to hold viscous fluid in which a portion of the piston resides;
a damper arm having a first end coupled to the platform support and a second end coupled to the piston, the damper arm being configured to rotate in a vertical plane with the second end rotating about the horizontal axis and the first end traversing an arc having the horizontal axis as its center; and
a spring configured to apply a spring force to the damper arm relative to rotation thereof.

2. The apparatus of claim 1, wherein the piston includes a proximal end residing in the housing and a distal end to which the piston extends out of the housing, the distal end being connected to the second end of the damper arm.

3. The apparatus of claim 2, wherein the housing has an internal cavity that is larger than the piston, the piston and housing being configured and arranged to facilitate interaction of the viscous fluid with a surface of the piston for damping rotation of the piston.

4. The apparatus of claim 1, further including the viscous fluid, the viscous fluid being configured and arranged with the piston to dampen movement of the platform support, by interacting with the piston to dampen changes in rotational torque applied to the piston via the damper arm, in response to the movement of the platform support.

5. The apparatus of claim 1, further comprising at least one auxiliary damper configured to dampen movement in a direction orthogonal to the vertical plane.

6. The apparatus of claim 1, wherein the spring is configured to dampen changes in rotation of the piston by resisting rotation of the first end of the piston about the arc.

7. The apparatus of claim 1, wherein the housing has a surface that is angled relative to a pre-loaded angle of the damper arm in a resting state, to orient the spring perpendicularly to the damper arm in the resting state.

8. The apparatus of claim 1, wherein the platform support is to restrict movement of the damper arm to movement within the vertical plane.

9. The apparatus of claim 1, further including a platform connected to the platform support, the platform being configured to hold an object.

10. The apparatus of claim 1, wherein the damping mechanism includes at least one seal to maintain the viscous fluid within the housing.

11. The apparatus of claim 1, wherein the piston has a barrel residing in the housing and a recessed gland region near an end of the barrel adjacent an opening in the housing, further including a seal residing in the recessed gland region and configured to maintain the viscous fluid within the housing.

12. An apparatus comprising:
a tray to hold one or more objects;
a plurality of platform supports, each support being coupled to the tray and to an underlying base;
for each of the platform supports, a damper mechanism including:
a rotary viscous damper having a piston configured to rotate about a horizontal axis, a housing having a viscous fluid in which a portion of the piston resides, and one or more seals coupled to seal the viscous fluid within the housing;
a damper arm having a first end coupled to the platform support and a second end coupled to the piston, the damper arm being configured to rotate in a vertical plane, with the second end rotating about the horizontal axis and the first end traversing an arc having the horizontal axis as its center; and
a spring configured to apply a spring force to the damper arm relative to rotation thereof, by engaging with a surface of the housing and a surface of the damper arm; and
a cap coupled to the housing and configured to apply pressure to the piston in a direction along the horizontal axis to maintain the piston within the housing.

13. The apparatus of claim 12, wherein the housing has a spring support surface that is inclined at an angle relative to a plane in which the horizontal axis lies, in which the spring support surface is parallel to a surface of the damper arm in a resting state corresponding to resting position of the damper arm with a predefined load in the tray, with the spring contacting and perpendicular to the spring support surface and the surface of the damper arm.

14. The apparatus of claim 12, wherein the piston has a barrel section having an outside diameter and being located within the housing, a pin end having a diameter that is smaller than the outside diameter, the barrel being part of a proximal end of the piston inserted within the housing, and the pin being part of a distal end of the piston that extends out of an opening in the housing and away from the barrel and housing to engage with the damper arm.

15. The apparatus of claim 14, further including:
a gland region in the barrel section, the gland region being located adjacent the opening of the housing and having a diameter that is less than the outside diameter of the barrel section; and
an O-ring in the gland region, the O-ring extending from the diameter of the gland region to the outside diameter of the barrel section, the O-ring being configured to engage with an outer surface of the gland region and an inner sidewall of the housing to provide a seal that maintains the viscous fluid within the housing.

16. The apparatus of claim 15, further including a U-cup seal through which the pin extends and abutting the distal end of the barrel section, and configured to further seal the viscous fluid within the housing.

17. The apparatus of claim 15, wherein:
the viscous fluid is configured and arranged with the piston to dampen movement of the platform support, by interacting with the piston to dampen changes in rotational torque applied to the piston via the damper arm, in response to the movement of the platform support; and
the spring is configured to resist movement of the damper arm by applying one or both of a compressive force that counters movement of the damper arm toward the spring, and an extension force that counters movement of the damper arm away from the spring.

18. A method comprising:
providing a platform support and a damping mechanism connected to the platform support, the damping mechanism including:
a rotary viscous damper having a piston configured to rotate about a horizontal axis, and having a housing configured to hold viscous fluid in which a portion of the piston resides;
a damper arm having a first end coupled to the platform support and a second end coupled to the piston, the damper arm being configured to rotate in a vertical plane with the second end rotating about the horizontal axis and the first end traversing an arc having the horizontal axis as its center; and
a spring configured to apply a spring force to the damper arm relative to rotation thereof; and
damping movement of a platform connected to the platform support, including using the rotary viscous damper and the spring to dampen rotation of the damper arm about the horizontal axis.

19. The method of claim 18, including using the viscous fluid to dampen movement of the platform support, by interacting with the piston to dampen changes in rotational torque applied to the piston via the damper arm, in response to the movement of the platform support, and using the spring to resist movement of the damper arm by applying one or both of a compressive force that counters movement of the damper arm toward the spring, and an extension force that counters movement of the damper arm away from the spring.

20. The method of claim 18, further including using a plurality of the platform supports and damping mechanisms, including a damping mechanism for each platform support, each platform support coupled to a tray and restricting motion of the respective damper arms of the damping mechanisms to movement within respective vertical planes.
